(19) United States
(12) Patent Application Publication
(10) Pub. No.: US 2023/0152818 A1
(43) Pub. Date: May 18, 2023

(54) OBJECT RECOGNITION BY AN ACTIVE OPTICAL SENSOR SYSTEM

(71) Applicant: Valeo Schalter und Sensoren GmbH, Bietigheim-Bissingen (DE)

(72) Inventors: Sergio Fernandez, Bietigheim-Bissingen (DE); Shuyun Guo, Bietigheim-Bissingen (DE); Albrecht Muenzenmaier, Bietigheim-Bissingen (DE); Andreas Reichert, Bietigheim-Bissingen (DE)

(73) Assignee: Valeo Schalter und Sensoren GmbH, Bietigheim-Bissingen (DE)

(21) Appl. No.: 17/914,963

(22) PCT Filed: Mar. 23, 2021
(86) PCT No.: PCT/EP2021/057349

§ 371 Date: Sep. 27, 2022

(30) Foreign Application Priority Data
Mar. 27, 2020 (DE) 10 2020 108 474.9

(51) Int. Cl. G05D 1/02; G01S 7/487; G01S 17/89

(52) U.S. Cl. CPC G05D 1/0231; G01S 7/4873; G01S 17/89

(57) ABSTRACT

According to a method for object recognition by an active optical sensor system (2), a detector unit (2b) detects light (3b) reflected off an object (4) and generates a sensor signal (5a, 5b, 5c, 5d, 5e, 5f) on the basis thereof. A computing unit (2c) ascertains a first pulse width (D1) defined by a first limit value (G1) for the amplitude of the sensor signal (5a, 5b, 5c, 5d, 5e, 5f) as well as a second pulse width (D2) defined by a corresponding second limit value (G2). The computing unit (2c) ascertains at least one property of the object (4) according to the first pulse width (D1) and according to the second pulse width (D2).

The present invention relates to a method for object recognition by an active optical sensor system, wherein light reflected by an object in an environment of the sensor system is registered by means of a detector unit of the sensor system and a sensor signal is generated on the basis of the registered light, and a first pulse width of a signal pulse of the sensor signal is determined by means of a computer unit, the first pulse width being established by a predetermined first limit value for an amplitude of the sensor signal. The invention furthermore relates to a method for the at least partially automatic control of a motor vehicle, to an active optical sensor system, to an electronic vehicle guidance system for a motor vehicle, and to computer program products.

Active optical sensor systems such as lidar systems may be fitted on motor vehicles in order to carry out various functions of electronic vehicle guidance systems or driver assistance systems. These functions include distance measurements, distance control algorithms, lane-keeping assist systems, object tracking functions, object recognition functions, object classification functions and the like.

The detected light in this case leads to an analog signal pulse having a time profile which reproduces the intensity of the detected light. In order to represent this information discretely, the signal pulse may for example be described by a particular pulse width which is defined by the time during which the pulse lies above a particular limit value. One disadvantage in this case is that the shape of the signal pulse is not taken into account. A comparatively flat and broad pulse may possibly be treated and processed in the same way as a comparatively steep pulse which has the same pulse width.

This may lead to the erroneous classification of objects, or to discrimination between different object classes on the basis of the corresponding sensor data not being reliably possible. For example, it may be the case that such methods cannot distinguish reliably between reflections from a roadway surface or a roadway marking, on the one hand, and another three-dimensional object having a small extent.

Document EP 1 557 694 B1 describes a method for classifying objects. In this case, the environment of a motor vehicle is sampled with a laser scanner and the echo pulse width of the reflected light pulse received is evaluated. A threshold value which the light pulse must exceed is defined, and the time difference from the threshold value being exceeded until the threshold value is subsequently fallen below is defined as the echo pulse width of the laser pulse.

Against this background, it is an object of the present invention to provide an improved concept for object recognition by an active optical sensor system, which allows a higher accuracy or reliability in the determination of object properties and/or in the classification of objects.

The improved concept is based on the idea of determining a first and a second pulse width of a sensor pulse of a sensor signal, the pulse widths being defined by different limit values. At least one property of the object is determined as a function of the two pulse widths.

According to the improved concept, a method for object recognition by an active optical sensor system, in particular an active optical sensor system of a motor vehicle, is provided. Light reflected by an object in an environment of the sensor system is registered by means of a detector unit of the sensor system and a sensor signal is generated by means of the detector unit on the basis of the registered light. A first pulse width of a signal pulse of the sensor signal is determined by means of a computer unit, in particular of the sensor system or of the motor vehicle, the first pulse width being established by a predetermined first limit value for an amplitude of the sensor signal. A second pulse width of the signal pulse is determined by means of the computer unit, the second pulse width being established by a predetermined second limit value, which is in particular different than the first limit value, for the amplitude of the sensor signal. At least one property of the object is determined by means of the computer unit as a function of the first pulse width and the second pulse width.

Here and below, an active optical sensor system may be defined as one that has an emitter unit with a light source, in particular for emitting light, for example in the form of light pulses. The light source may, in particular, be configured in the form of a laser. Furthermore, an active optical sensor system has the detector unit with at least one optical detector, in particular for registering light or light pulses, in particular reflected components of the emitted light.

Here and below, the term “light” may be understood as comprising electromagnetic waves in the visible range, in the infrared range, and/or in the ultraviolet range. Accordingly, the term “optical” may also be understood as relating to light in this sense.

The light which is emitted by the active optical sensor system may in particular include infrared light, for example having a wavelength of 905 nm, approximately 905 nm, 1200 nm or approximately 1200 nm. These wavelength specifications may in this case respectively relate to a wavelength range having a broad distribution, as is typical of the corresponding light source.

In the present case of the active optical sensor system, the light source may, for example, be a laser light source. The wavelengths mentioned may, within the framework of customary tolerances, correspond for example to peak wavelengths of the laser spectrum.

In particular, light is emitted in the direction of the object by means of an emitter unit of the sensor system and the reflected light registered consists of components of the emitted light that are reflected by the object.

The sensor signal it is in particular an analog time-dependent signal, which represents as a function of time a quantity equivalent to a signal power or signal intensity to be detected. For example, the sensor signal may correspond to a detector current of an optical detector of the detector unit as a function of time, particularly if the detector contains a photodiode, for example an avalanche photodiode (APD).

The signal pulse is in particular a part of the sensor signal, that is to say the sensor signal during a particular time period. Within this time period, a minimum threshold value for the amplitude of the sensor signal is exceeded and subsequently fallen below again, in particular exceeded precisely once and subsequently fallen below precisely once. The minimum threshold value may in this case be equal to one of the limit values or less than the first and the second limit value.

By defining a limit value for the amplitude of the sensor signal, a pulse width is correspondingly established in that the pulse width corresponds to the time interval during which the amplitude of the sensor signal is greater than the corresponding limit value.

According to such a definition, the first pulse width and/or the second pulse width may also be equal to zero, particularly if the maximum amplitude of the sensor signal during the signal pulse is always less than the corresponding limit value.

By taking into account two different pulse widths, defined by two different limit values, the pulse shape of the signal pulse may be taken into account to a certain extent according to the improved concept. This represents additional information for determining the property of the object, or for classifying the object. In this way, in particular, a higher accuracy and/or an improved reliability may be achieved in the determination of the property of the object, or in the object classification.

According to at least one embodiment of the method according to the improved concept, the first limit value is less than the second limit value.

According to at least one embodiment, the active optical sensor system is configured as a lidar system.

According to at least one embodiment, the sensor system is the sensor system of a motor vehicle and the object is located in an environment of the motor vehicle.

According to at least one embodiment, the property of the object is determined by means of the computer unit as a function of a difference between the first pulse width and the second pulse width.

The pulse shape may be deduced with the aid of the difference. For example, it is possible to determine whether a comparatively steep or flat pulse is involved. The steeper the pulse is, for example, the less the difference between the two pulse widths is.

This information may then be used for reliable discrimination of different objects in the scope of an object classification and/or for more reliable determination of the property of the object. A class or a type of the object may in this case be regarded as a property of the object.

According to at least one embodiment, the property of the object is determined by means of the computer unit as a function of a ratio of the first pulse width to the second pulse width.

In other words, by means of the computer unit a quotient of the pulse widths is formed and the property is determined as a function of the quotient.

Like the difference, the ratio may be used to quantify the pulse shape, in particular the steepness of the pulse. The ratio is, however, in this case independent of the absolute values of the pulse widths.

Depending on the property to be determined, or depending on the nature of the object, the difference or the ratio may be more suitable for the determination of the property or for the classification.

According to at least one embodiment, the property of the object contains a reflectivity of the object.

A higher reflectivity of the object tends to lead to a higher energy of the reflected light and accordingly to broader signal pulses, and correspondingly to a greater difference between the pulse widths, particularly if the signal pulse exceeds a saturation limit value of the detector unit, or of an optical detector of the detector unit.

Since the reflectivity allows conclusions relating to the nature of the object, for example its surface condition or the like, more reliable distinctions may therefore be made between different objects. For example, roadway markings may be distinguished reliably from other regions of the roadway surface with the aid of the reflectivity. Traffic signs, which generally have a high reflectivity, plants, which generally have a low reflectivity, and the like may also be correspondingly classified with the aid of the reflectivity.

According to at least one embodiment, the at least one property of the object contains an extent of the object in a radial direction with respect to the sensor system, or with respect to the detector unit.

Each sensor signal may, for example, be assigned to a particular incidence direction of the registered light. The radial direction then corresponds, for example, to this incidence direction of the reflected light.

The smaller the extent is, for example, the less the difference between the two pulse widths is.

Depending on the configuration of the sensor system, the incidence direction of the light may be established by different parameters. For example, in the case of sensor systems having a rotating mirror in order to direct the incident light onto the corresponding detector, the mirror setting may be used to determine the incidence direction within a particular plane, and a position of the corresponding detector perpendicularly to this plane may define the incidence direction perpendicularly thereto.

By determining the extent of the object in the radial direction, or in other words by determining the radial region from which the corresponding reflections come, conclusions may likewise be drawn relating to the nature of the object. For example, roadway markings can typically have a relatively large extent in the radial direction, while small objects that are located on the surface of the roadway have a smaller extent. In this way, distinction may reliably be made between roadway markings and such small objects.

According to at least one embodiment, a classification of the object is carried out by means of the computer unit as a function of the first and the second pulse width and/or as a function of the property of the object.

In particular, a predefined class is assigned to the object as a function of the property and/or as a function of the pulse widths.

The information relating to the class, or in other words a result of the classification, may then be used for further functionalities, for example for control of the motor vehicle.

According to at least one embodiment, whether the object is part of a roadway for a motor vehicle or whether the object is a roadway marking on the roadway is established by means of the computer unit on the basis of the first and on the basis of the second pulse width and/or on the basis of the property of the object.

In such embodiments, the motor vehicle contains in particular the active optical sensor system.

Establishing whether the object is a part of the roadway or the roadway marking may be understood as part of the classification or corresponds to the classification of the object.

By establishing whether or not the object is the part of the roadway or the roadway marking these may be distinguished from other small objects in the vicinity of the ground, which may be of different importance for controlling of the motor vehicle.

According to at least one embodiment, at least one further pulse width of the signal pulse is determined by means of the computer unit, each further pulse width of the at least one further pulse width being established by an associated predetermined further limit value for the amplitude of the sensor signal. The at least one property of the object is determined by means of the computer unit as a function of the first pulse width and the second pulse width and the at least one further pulse width.

The at least one further pulse width is, in this case, in particular less than the second pulse width and in particular greater than the first pulse width.

By taking into account the further pulse widths according to the further limit values between the first and the second limit value, the pulse shapes of the signal pulses may be estimated with even higher accuracy and reliability, which consequently leads to a further increase in the accuracy and reliability of the determination of the property of the object, or of the object classification.

According to at least one embodiment, the second limit value is greater than the first limit value and the first limit value is greater than a predetermined noise level, or a corresponding characteristic for the noise level, of the detector unit.

This may advantageously prevent signal noise from being falsely interpreted. The reliability of the method is thereby increased further.

According to at least one embodiment, the method involves determining the predetermined noise level on the basis of test measurements.

According to at least one embodiment, the second limit value is greater than the first limit value, and the second limit value is greater than a predetermined saturation limit value of the detector unit.

The saturation limit value may, for example, correspond to a maximum detector current so that the sensor signal is clipped at the saturation limit value, irrespective of a possibly higher intensity of the incident light.

Above the saturation limit value, a pulse width is therefore not meaningful, or is identically equal to zero.

According to at least one embodiment, the saturation limit value is determined beforehand in the method by further test measurements.

According to the improved concept, a method for the at least partial automatic control of a motor vehicle is also provided. At least one property of an object in an environment of the motor vehicle is determined by means of a method for object recognition according to the improved concept. The motor vehicle is controlled at least partially automatically as a function of the at least one property of the object, in particular as a function of a result of the classification of the object.

The at least partially automatic control of the motor vehicle is in this case carried out, for example, by means of an electronic vehicle guidance system of the motor vehicle. The vehicle guidance system in this case contains a control device and optionally further sensor systems and optionally actuators.

In particular, the vehicle guidance system may contain an active optical sensor system as described or the computer unit of the active optical sensor system.

Here and below, an electronic vehicle guidance system may be understood as an electronic system which is adapted to guide or control the motor vehicle fully automatically or fully autonomously, without control intervention by a driver being necessary. The motor vehicle, or the electronic vehicle guidance system, in this case independently or fully automatically carries out any necessary steering, braking and/or acceleration maneuvers. In particular, the electronic vehicle guidance system may be used to implement a fully automatic or fully autonomous driving mode of the motor vehicle according to Level 5 of the classification according to SAE J3016. An electronic vehicle guidance system may also be understood as an advanced driver assistance system (ADAS), which assists the driver during partially automated or partially autonomous driving of the motor vehicle. In particular, the electronic vehicle guidance system may be used to implement a partially automated or partially autonomous driving mode of the motor vehicle according to one of Levels 1 to 4 according to the SAE J3016 classification. Here and below, “SAE J3016” refers to the corresponding standard in the version of June 2018.

The at least partially automatic control, which may also be referred to as at least partially automatic vehicle guidance, may therefore involve guiding the motor vehicle according to a fully automatic or fully autonomous driving mode of Level 5 according to SAE J3016. The at least partially automatic vehicle guidance may also involve guiding the motor vehicle according to a partially automated or partially autonomous driving mode according to one of Levels 1 to 4 according to SAE J3016.

According to at least one embodiment of the method for at least partially automatic control of the motor vehicle according to the improved concept, the method for object recognition according to the improved concept involves carrying out the classification of the object as a function of the first and the second pulse width. The motor vehicle is controlled at least partially automatically as a function of a result of the classification.

According to the improved concept, an active optical sensor system, in particular for a motor vehicle, is also provided. The sensor system has a detector unit, which is adapted to register light reflected by an object in an environment of the sensor system and to generate a sensor signal on the basis of the registered light. The sensor system has a computer unit, which is adapted to determine a first pulse width of a signal pulse of the sensor signal, the first pulse width being established by a predetermined first limit value for an amplitude of the sensor signal. The computer unit is adapted to determine a second pulse width of the signal pulse, the second pulse width being established by a predetermined second limit value for the amplitude of the sensor signal. The computer unit is adapted to determine at least one property of the object as a function of the first pulse width and as a function of the second pulse width.

In particular, the active optical sensor system has an emitter unit, which is adapted to emit light in the direction of the object, and the detector unit is adapted to register components of the emitted light that are reflected by the object and to generate the sensor signal on the basis thereof.

Further embodiments of the active optical sensor system according to the improved concept result directly from the various configurations of the method for object recognition according to the improved concept, and vice versa. In particular, an active optical sensor system according to the improved concept may be adapted or programmed to carry out a method according to the improved concept, or carries out such a method.

According to the improved concept, an electronic vehicle guidance system which has an active optical sensor system according to the improved concept is also provided. The vehicle guidance system furthermore has a control device, which is adapted to generate at least one control signal as a function of the at least one property of the object, in order to control the motor vehicle at least partially automatically.

The control device may in this case contain, for example, the computer unit of the active optical sensor system.

According to the improved concept, a motor vehicle having an electronic vehicle guidance system according to the improved concept or having an active optical sensor system according to the improved concept is also provided.

According to the improved concept, a first computer program having first instructions is provided. When the first instructions, or the first computer program, are executed by an active optical sensor system according to the improved concept, the first instructions cause the sensor system to carry out a method for object recognition according to the improved concept.

According to the improved concept, a second computer program having second instructions is also provided. When the second instructions are executed by an electronic vehicle guidance system according to the improved concept, or when the second computer program is executed by the vehicle guidance system, the second instructions cause the vehicle guidance system to carry out a method for the at least partially automatic control of a motor vehicle according to the improved concept.

According to the improved concept, a computer-readable storage medium, on which a first computer program according to the improved concept and/or a second computer program according to the improved concept is stored, is also provided.

The computer programs according to the improved concept and the computer-readable storage medium may also be regarded as respective computer program products having the corresponding first and/or second instructions.

Further features of the invention may be found from the claims, the figures and the description of the figures. The features and combinations of features mentioned above in the description and the features and combinations of features mentioned below in the description of the figures and/or shown in the figures alone may be used not only in the particular combination indicated but also in other combinations without departing from the scope of the invention. Embodiments of the invention that are not explicitly shown and explained in the figures, but emerge and are producible from the explained embodiments by virtue of separate combinations of features, are therefore also intended to be regarded as encompassed and disclosed. Embodiments and combinations of features which therefore do not have all the features of an originally formulated independent claim are also intended to be regarded as disclosed. Furthermore, embodiments and combinations of features that go beyond or differ from the combinations of features set out in the back-references of the claims are intended to be regarded as disclosed, in particular by the embodiments set out above.

In the figures:

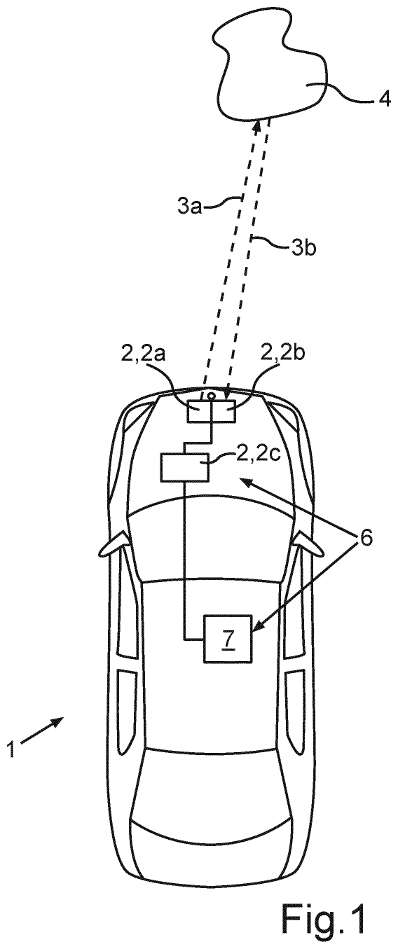

FIG. 1 shows a schematic representation of a motor vehicle with an exemplary embodiment of an electronic vehicle guidance system according to the improved concept;

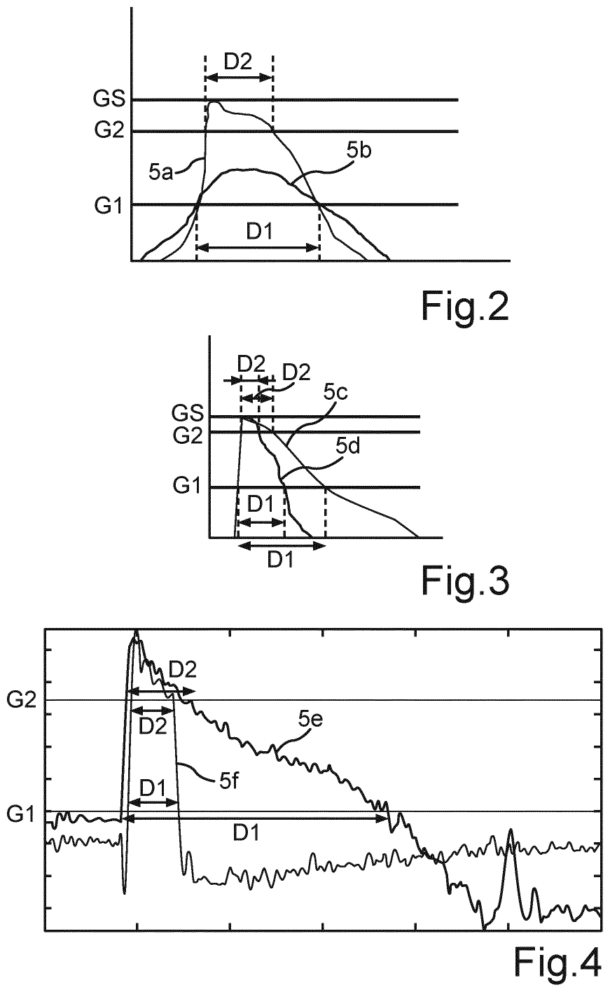

FIG. 2 shows a schematic representation of sensor signals of a detector unit of an exemplary embodiment of an active optical sensor system according to the improved concept;

FIG. 3 shows a schematic representation of further sensor signals of a detector unit of a further exemplary embodiment of an active optical sensor system according to the improved concept;

FIG. 4 shows a schematic representation of further sensor signals of a detector unit of a further exemplary embodiment of an active optical sensor system according to the improved concept;

FIG. 5 shows a schematic representation of a camera image and a point cloud generated by a further exemplary embodiment of an active optical sensor system according to the improved concept;

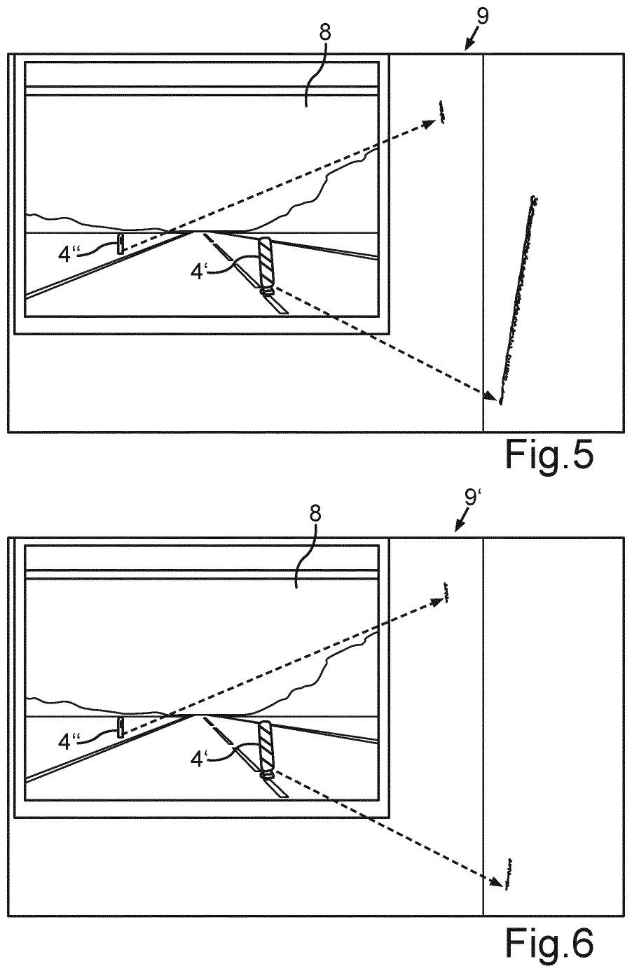

FIG. 6 shows a schematic representation of a camera image and a point cloud generated by a further exemplary embodiment of an active optical sensor system according to the improved concept; and

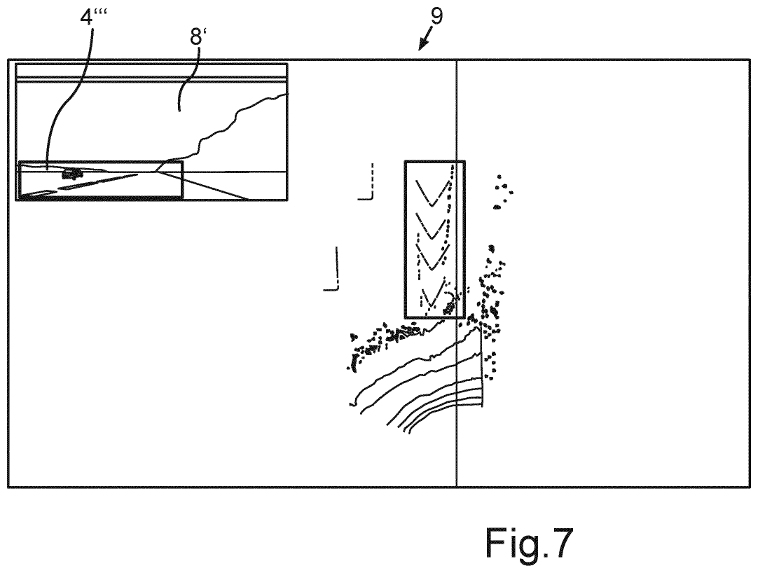

FIG. 7 shows a schematic representation of a camera image and a point cloud generated by a further exemplary embodiment of an active optical sensor system according to the improved concept.

FIG. 1 illustrates a motor vehicle 1 which has an electronic vehicle guidance system 6 according to the improved concept.

The electronic vehicle guidance system 6 has, in particular, an active optical sensor system 2 according to the improved concept. Optionally, the vehicle guidance system 6 may also have a control device 7.

The active optical sensor system 2 has an emitter unit 2a, which contains for example an infrared laser. The sensor system 2 furthermore has a detector unit 2b, which contains for example one or more optical detectors, for example APDs.

The sensor system 2 furthermore has a computer unit 2c. Functions of the computer unit 2c which are described below may also be undertaken in various configurations by the control device 7, or vice versa.

The emitter unit 2a emits laser pulses 3a into the environment of the motor vehicle 1, where they are partially reflected by an object 4 and at least partially reflected back as reflected pulses 3b in the direction of the sensor system 2, and in particular of the detector unit 2b. The detector unit 2b, in particular the optical detectors of the detector unit 2b, registers the reflected components 3b and, on the basis thereof, generate a time-dependent sensor signal which has an amplitude that is proportional to the radiation intensity or radiation power of the registered light 3b. Corresponding examples of various signal pulses are represented in FIG. 2 to FIG. 4.

The computer unit 2c determines a first time interval, during which the sensor signal 5a, 5b, 5c, 5d, 5e, 5f exceeds a first limit value G1. This first time interval then corresponds to the first pulse width D1 of the corresponding signal pulse. In the same way, the computer unit 2c determines a second pulse width D2 by corresponding comparison of the sensor signal 5a, 5b, 5c, 5d, 5e, 5f with a second limit value G2, which is greater than the first limit value G1.

The computer unit 2c or the control device 7 may then determine a property of the object 4, for example a reflectivity or an extent of the object 4, on the basis of the first pulse width D1 and the second pulse width D2.

In particular, the computer unit 2c or the control device 7 may classify the object 4 as a function of the property, for example the pulse widths D1, D2.

On the basis of a result of the classification, or on the basis of the property of the object, the control device 7 then for example generates control signals in order to control the motor vehicle 1 at least partially automatically.

FIG. 2 represents two exemplary sensor signals 5a, 5b, which approximately have the same first pulse width D1. While the sensor signal 5a contains a comparatively steep pulse, the pulse of the sensor signal 5b has a flatter profile. These different pulse shapes are reflected in the different second pulse widths D2. In particular, the second pulse width D2 for the sensor signal 5a is greater than zero, in other words the signal pulse of the sensor signal 5a exceeds the second limit value G2, while this is not the case for the signal pulse of the sensor signal 5b, for which reason the corresponding second pulse width is equal to zero here.

For example, the sensor signal 5a may correspond to light which has been reflected by an object having a relatively small extent, which is located on a roadway surface. The pulse shape of the sensor signal 5b, on the other hand, is for example typical of a roadway marking on the roadway surface. Correspondingly, small objects may be distinguished from roadway markings because of the different pulse widths D1, D2, which would not be the case when using only the first pulse width D1.

If APDs are used as optical detectors, for example, a saturation limit value GS may for example be of the order of a few hundreds of mV, for example lying between 100 mV and 1000 mV.

In the manner described, for example, points on the ground may be distinguished from “genuine” targets.

FIG. 3 shows two further exemplary sensor signals 5c, 5d, both of which correspond to the case of saturation, that is to say in other words they have signal pulses which reach the saturation limit value GS.

Accordingly, both the first pulse width D1 and the second pulse width D2 are greater than zero for both signal pulses of the sensor signals 5c, 5d.

Particularly in cases in which it may be assumed that all signal pulses reach the saturation limit value GS, two limit values G1, G2 and correspondingly two pulse widths D1, D2 are already suitable for reproducing the pulse shape of the sensor signals 5c, 5d sufficiently accurately.

If the detector unit 2b is operated in such a way that saturation of the pulses is not necessarily ensured, it may be advantageous to insert further limit values between the two limit values G1, G2 and correspondingly to determine further pulse widths, in order to obtain more information relating to the pulse shape.

FIG. 4 shows a further example of two further sensor signals 5e, 5f. Here again, for example, the sensor signal 5e may correspond to reflections from a roadway marking while the sensor signal 5f may correspond to reflections from a small object on the surface of the roadway.

Consequently, in this case the two second pulse widths D2 are greater than zero and are approximately equal, or at least similar. However, the first pulse widths D1 differ significantly between the sensor signals 5e, 5f. In this way, conclusions may again be drawn relating to the signal pulse shape, and then also the nature of the object.

FIG. 5 schematically represents a situation from the view of a motor vehicle 1. A camera image 8 shows a reflector post 4′, which is arranged on a roadway for the motor vehicle 1, as well as a guide post 4″ which is arranged next to the roadway. Corresponding point clouds 9 of the sensor system 2 are furthermore represented. Points of the point cloud are in this case positioned according to their position in the environment of the motor vehicle, and the point cloud 9 in this case indicates all those points which have led to a sensor signal whose maximum amplitude exceeds the first limit value G1.

FIG. 6 represents the same camera image 8 with a further a further point cloud 9′. The further point cloud 9′ in this case corresponds substantially to the point cloud 9, with the difference that only those points whose corresponding sensor signal exceeds the second limit value G2 are represented. As may readily be seen, the difference in the point clouds 9, 9′ for the guide posts 4″ is relatively small, while there is a significant difference for the reflector posts 4′.

FIG. 7 represents a further example from the view of the motor vehicle 1. Here, a further camera image 8′ in which V-shaped roadway markings 4m can be seen is shown. The corresponding point cloud 9″ shows the corresponding points. The reflectivity of the roadway markings 4″' is in this case high enough for the corresponding sensor signals to exceed both limit values G1, G2. In this case, however, as explained with reference to FIG. 2 to FIG. 4, the difference between the first pulse width D1 and the second pulse width D2 is more pronounced than would be the case, for example, with other objects on the roadway surface.

As described, the improved concept provides a possible way of carrying out object recognition by an active optical sensor system with higher reliability and higher accuracy. Correspondingly, functions for automatic or partially automatic vehicle guidance may likewise be carried out with higher accuracy or reliability and safety.

1. A method for object recognition by an active optical sensor system, comprising:
registering light reflected by an object in an environment of the sensor system by a detector unit of the sensor system and generating a sensor signal on the basis of the registered light;
determining a first pulse width of a signal pulse of the sensor signal by a computer unit, the first pulse width being established by a predetermined first limit value for an amplitude of the sensor signal;
determining a second pulse width of the signal pulse is by the computer unit, the second pulse width being established by a predetermined second limit value for the amplitude of the sensor signal; and
determining at least one property of the object by the computer unit as a function of the first pulse width and the second pulse width.

2. The method as claimed in claim 1, wherein the property of the object is determined as a function of a difference between the first pulse width and the second pulse width.

3. The method as claimed in claim 1, wherein the property of the object is determined as a function of a ratio between the first pulse width to the second pulse width.

4. The method as claimed in claim 1, wherein the at least one property contains a reflectivity of the object.

5. The method as claimed in claim 1, wherein the at least one property contains an extent of the object in a radial direction with respect to the sensor system.

6. The method as claimed in claim 1, wherein a classification of the object is carried out by the computer unit as a function of the first and the second pulse width.

7. The method as claimed in claim 1, wherein whether the object is part of a roadway for a motor vehicle or a roadway marking of the roadway is established by means of the computer unit on the basis of the first and the second pulse width.

8. The method as claimed in claim 1, wherein at least one further pulse width of the signal pulse is determined by means of the computer unit, each further pulse width of the at least one further pulse width being established by an associated predetermined further limit value for the amplitude of the sensor signal; and the at least one property of the object is determined by the computer unit as a function of the at least one further pulse width.

9. The method as claimed in claim 1, wherein the second limit value is greater than the first limit value and the first limit value is greater than a predetermined noise level of the detector unit; and/or the second limit value is greater than the first limit value, and the first limit is greater than a predetermined saturation limit value of the detector unit.

10. A method for the at least partially automatic control of a motor vehicle, comprising: determining at least one property of an object in an environment of the motor vehicle by a method for object recognition as claimed in claim 1; and controlling the motor vehicle at least partially automatically as a function of the at least one property of the object.

11. The method as claimed in claim 10, wherein the at least one property of an object is determined by classification of the object carried out by the computer unit as a function of the first and the second pulse width; and the motor vehicle is controlled at least partially automatically as a function of a result of the classification.

12. An active optical sensor system, comprising:
a detector unit, which is adapted to register light reflected by an object in an environment of the sensor system and to generate a sensor signal on the basis of the registered light; and
a computer unit, which is adapted to determine a first pulse width of a signal pulse of the sensor signal, the first pulse width being established by a predetermined first limit value for an amplitude of the sensor signal;
the computer unit is adapted to determine a second pulse width of the signal pulse, the second pulse width being established by a predetermined second limit value for the amplitude of the sensor signal; and
the computer unit is adapted to determine at least one property of the object as a function of the first pulse width and the second pulse width .

13. An electronic vehicle guidance system for a motor vehicle, comprising an active optical sensor system as claimed in claim 12; and
a control device, which is adapted to generate at least one control signal as a function of the at least one property of the object, in order to control the motor vehicle at least partially automatically.

14.-15. (canceled)
